(19) United States
(12) Patent Application Publication
(10) Pub. No.: US 2021/0300249 A1
(43) Pub. Date: Sep. 30, 2021

(54) VEHICLE BODY REAR PART STRUCTURE

(71) Applicant: HONDA MOTOR CO., LTD., Tokyo (JP)

(72) Inventors: Kazutaka NAKABE, Wako-shi (JP); Kei KOBAYASHI, Wako-shi (JP); Kotone NAKAO, Wako-shi (JP); Mai NUMAZAWA, Wako-shi (JP); Tomohiro ITO, Wako-shi (JP)

(73) Assignee: HONDA MOTOR CO., LTD., Tokyo (JP)

(21) Appl. No.: 17/209,704

(22) Filed: Mar. 23, 2021

(30) Foreign Application Priority Data
Mar. 30, 2020 (JP) 2020-060453

(51) Int. Cl. B60R 3/02; B62D 25/08; B60J 5/10

(52) U.S. Cl. CPC B60R 3/02; B60J 5/108; B62D 25/087

(57) ABSTRACT

A vehicle body rear part structure according to an aspect of the present invention includes: an opening/closing part that is capable of opening and closing a rear opening part of a vehicle main body that continues to an inside of a load room; and a step that is rotatably connected to a rear end part of the vehicle main body and that has a load placement surface. The step rotates between a use position at which the load placement surface faces upward at a further rear position than a rear end of the vehicle main body and at a lower position than a floor surface of the load room and a storage position at which the load placement surface stands upright compared to the use position.

### CROSS-REFERENCE TO RELATED APPLICATION

Priority is claimed on Japanese Patent Application No. 2020-060453, filed on Mar. 30, 2020, the contents of which are incorporated herein by reference.

### BACKGROUND

### Field of the Invention

The present invention relates to a vehicle body rear part structure.

### Background

In a vehicle that includes a load room at a vehicle body rear part, for example, Japanese Unexamined Patent Application, First Publication No. H1-282040 discloses a configuration that includes a slide table capable of being pulled out in a vehicle body rearward direction through a slit that is formed between a back door and a rear bumper.

According to this configuration, since a load to be loaded in the load room can be placed on the slide table, it is possible to perform the loading without placing the load on the ground.

### SUMMARY

However, in Japanese Unexamined Patent Application, First Publication No. H1-282040, since the slide table is capable of being pulled out between the back door and the rear bumper, an upper surface of the slide table is set at a height equal to that of a floor surface of the load room. Therefore, in a vehicle in which the height of the floor surface of the load room is relatively high, for example, efforts are required to lift a load that is placed on the ground to the slide table. Accordingly, there is still room for improvement in terms of improving the convenience when a load is carried into and out of the load room.

An object of an aspect of the present invention is to provide a vehicle body rear part structure that is capable of improving the convenience when a load is carried into and out of a load room.

A vehicle body rear part structure according to a first aspect of the present invention includes: an opening/closing part that is capable of opening and closing a rear opening part of a vehicle main body that continues to an inside of a load room; and a step that is rotatably connected to a rear end part of the vehicle main body and that has a load placement surface, wherein the step rotates between a use position at which the load placement surface faces upward at a further rear position than a rear end of the vehicle main body and at a lower position than a floor surface of the load room and a storage position at which the load placement surface stands upright compared to the use position.

A second aspect of the present invention is the vehicle body rear part structure according to the first aspect described above, wherein the load room may be formed above an equipment accommodation part storing drive equipment of a vehicle and be separated by a partition wall, and the floor surface may be constituted of an upper surface of the partition wall.

A third aspect of the present invention is the vehicle body rear part structure according to the first or second aspect described above, wherein when the step is at the storage position, an upper end of the step may be located at a lower position than the floor surface.

A fourth aspect of the present invention is the vehicle body rear part structure according to any of the first to third aspects described above, wherein a guide part that extends downward from the floor surface toward a rearward direction may be formed on a lower end opening edge of the rear opening part.

A fifth aspect of the present invention is the vehicle body rear part structure according to any of the first to fourth aspects described above, wherein the step may be provided on a portion in a vehicle width direction of an entire area of the lower end opening edge of the rear opening part.

A sixth aspect of the present invention is the vehicle body rear part structure according to any of the first to fourth aspects described above, wherein a plurality of steps may be provided in a vehicle width direction at a rear end part of the vehicle main body.

A seventh aspect of the present invention is the vehicle body rear part structure according to any of the first to sixth aspects described above, wherein a lock portion that locks the step located at the storage position may be provided on the vehicle main body.

According to the first aspect described above, when the step is at the use position, the load placement surface is arranged at a further rear position than the rear end of the vehicle main body and at a lower position than the floor surface of the load room. Therefore, a load can be placed on the load placement surface when the load is carried into and out of the load room. Accordingly, it is possible to reduce the burden and improve the convenience when the load is carried into and out of the load room compared to a case where the road is directly lifted from the ground to the floor surface or the like.

According to the second aspect described above, since the equipment accommodation part is arranged below the load room, even in a case where the floor surface is set to a relatively high position, the load can be smoothly carried in and out by using the step.

According to the third aspect described above, since the upper end of the step does not protrude further upward than the floor surface of the load room, for example, even in a case where the step is not used, it is possible to prevent the upper end of the step from interfering when the load is carried in and out.

According to the fourth aspect described above, the load is carried into and out of the load room along the guide part, and thereby, it is possible to reduce the burden and improve the convenience when the load is carried into and out of the load room.

According to the fifth aspect described above, even when the step is at the use position, a user can approach the rear opening part by standing at the side of the step. In this case, since it is possible to access the rear opening part without interposing the step, it is possible to further facilitate the transportation of the load between the load room and the step.

According to the sixth aspect described above, it is possible to select a step that is set to the use position in accordance with the environment around the vehicle, the use mode of the vehicle, or the like. Therefore, it is possible to further improve the convenience.

According to the seventh aspect described above, it is possible to stably hold the step at the storage position when the step is not used.

### BRIEF DESCRIPTION OF THE DRAWINGS

FIG. 1 is a schematic configuration view of a vehicle according to an embodiment.

FIG. 2 is a schematic configuration view of a vehicle body rear part structure according to a first embodiment showing a state in which a step is at a storage position.

FIG. 3 is a schematic configuration view of the vehicle body rear part structure according to the first embodiment showing a state in which the step is at a use position.

FIG. 4 is a schematic configuration view of a vehicle body rear part structure according to a second embodiment showing a condition in which a step is at a storage position.

FIG. 5 is a schematic configuration view of the vehicle body rear part structure according to the second embodiment showing a state in which the step is at a use position.

FIG. 6 is a perspective view of a vehicle body rear part structure viewed from a rearward direction according to a third embodiment.

FIG. 7 is a perspective view of a vehicle body rear part structure viewed from a rearward direction according to a fourth embodiment.

### DESCRIPTION OF EMBODIMENTS

Hereinafter, embodiments of the present invention will be described with reference to the drawings. In the following description, frontward, rearward, upward, downward, leftward, and rightward directions are the same as directions in a vehicle 1 unless otherwise specified. In this case, an arrow FR in the drawing indicates a frontward direction of the vehicle 1, an arrow UP indicates an upward direction of the vehicle 1, and an arrow LH indicates a leftward direction of the vehicle 1. Further, in each of the embodiments described below, there may be cases in which the same reference numeral is given to corresponding members, and descriptions thereof may be omitted. In the following description, for example, an expression representing a relative or absolute arrangement such as “parallel”, “orthogonal”, “center”, or “coaxial” not only strictly represents such an arrangement but also represents a state of relative displacement with a tolerance or an angle or a distance sufficient to obtain the same function.

### First Embodiment

[Vehicle 1]

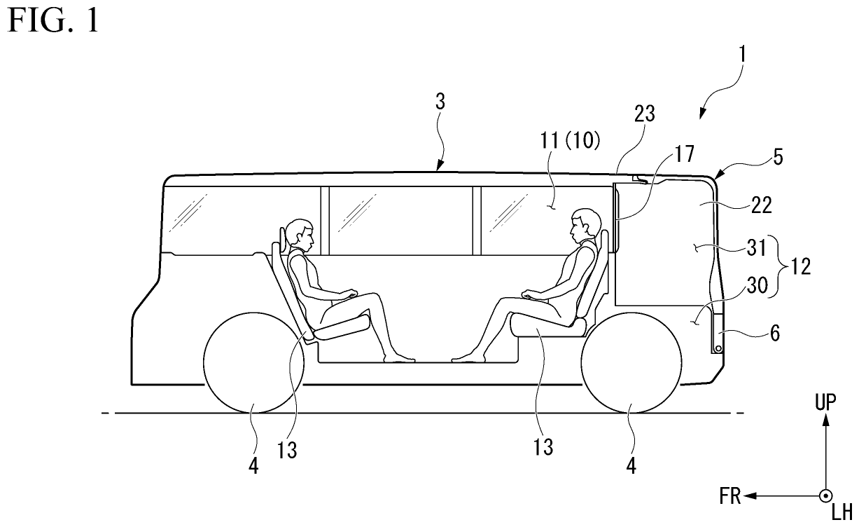

FIG. 1 is a schematic configuration view of the vehicle 1.

The vehicle 1 shown in FIG. 1 is, for example, a four-wheel automated driving vehicle using an electric motor as a drive source. The vehicle 1 is used for public transportation (for example, ride-share, a bus, or the like) and transports a user together with baggage to a destination. The drive source of the vehicle 1 is not limited to an electric motor and may be an internal combustion engine, a combination of an electric motor and an internal combustion engine, or the like. Further, the vehicle 1 is not limited to an automated driving vehicle and may be a manual driving vehicle.

The vehicle 1 includes a vehicle main body 3, a wheel 4, a tail gate 5 (opening/closing part), and a step 6. The electric motor described above may be directly connected to an axle of each wheel 4 or may be connected to the wheel 4 via a drive shaft. A vehicle body rear part structure according to the present embodiment is constituted of the tail gate 5 and the step 6.

The vehicle main body 3 defines a vehicle room 10. The vehicle room 10 is compartmented into a riding space 11 and a rear space 12.

A seat 13 on which a user can be seated is provided in the riding space 11. In the example shown in the drawing, a plurality of seats 13 are provided in a vehicle width direction in a state where the seats 13 face each other in a front-to-rear direction. The layout of the seat 13 can be changed accordingly.

The rear space 12 is provided in the vehicle room 10 behind the riding space 11 to be separated by a partition wall 17. In the rear space 12, a bottom wall is constituted of a floor panel (not shown) of the vehicle main body 3, both side walls are constituted of a side panel 22, and a top wall is constituted of a roof panel 23.

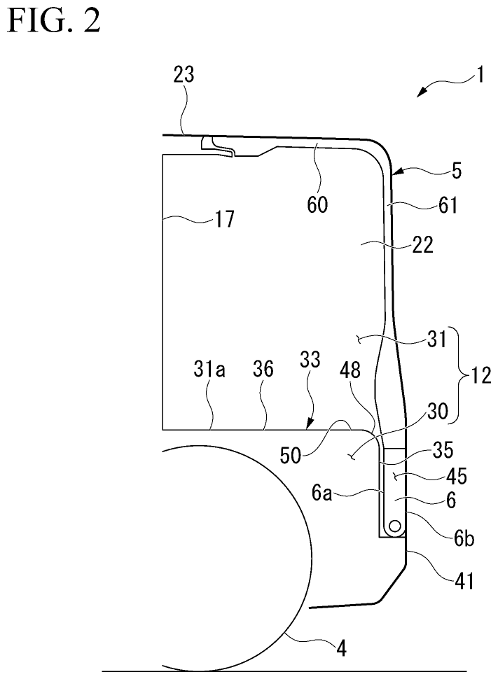

FIG. 2 is a schematic configuration view of a vehicle body rear part structure showing a state in which the step 6 is at a storage position.

As shown in FIG. 2, the rear space 12 includes an equipment accommodation part 30 and a load room 31.

A drive device of the vehicle 1 such as a battery as an electric power source, an electric power converter that connects the battery to the electric motor, or the like is mounted in the equipment accommodation part 30. The equipment accommodation part 30 is partitioned by a partition wall 33. In the present embodiment, the partition wall 33 includes a rear wall part 35 that partitions the equipment accommodation part 30 in the front-to-rear direction behind the equipment accommodation part 30 and an upper wall part 36 that partitions the equipment accommodation part 30 in the vertical direction above the equipment accommodation part 30.

The rear wall part 35 extends upward with respect to a rear bumper 41 from a part located at a further front position than the rear bumper 41 that constitutes a rear end of the vehicle main body 3. Accordingly, a recessed part 45 that opens rearward and upward is formed at a part of the vehicle main body 3 that is located above the rear bumper 41 and behind the rear wall part 35. The recessed part 45 extends in the vehicle width direction over the entire region of a lower end opening edge of a rear opening part 50 described below.

The upper wall part 36 extends frontward from an upper end portion of the rear wall part 35. A front end portion of the upper wall part 36 is connected to the partition wall 17 described above. Further, the upper wall part 36 spans a space between the side panels 22 in the vehicle width direction. A corner part formed of a rear end portion of the upper wall part 36 and the upper end portion of the rear wall part 35 constitutes a guide part 48 that extends downward toward the rearward direction. In the present embodiment, the guide part 48 is formed in an arc shape protruding rearward and upward. However, the guide part 48 may be an inclined surface or the like.

A load room 31 is provided to be separated by the upper wall part 36 above the equipment accommodation part 30. The load room 31 is partitioned by the side panel 22, the roof panel 23, the partition wall 17, and the upper wall part 36. In the present embodiment, a rear end of the roof panel 23 is located at a further front position than a rear end of the upper wall part 36. Accordingly, the rear opening part 50 of the load room 31 opens rearward and upward.

However, the rear opening part 50 may open at least rearward.

An upper surface of the upper wall part 36 described above constitutes a floor surface 31a of the load room 31. In the present embodiment, the floor surface 31a is, for example, located at a higher position than a seat surface of the seat 13. However, the height of the floor surface 31a (the height from the ground) can be changed accordingly. Further, the present embodiment is described using a configuration in which the rear space 12 includes the equipment accommodation part 30 and the load room 31; however, the rear space 12 may include at least the load room 31.

The tail gate 5 is a tail gate of a so-called hatchback type (flip-up type) and opens and closes the rear opening part 50. The tail gate 5 is formed in an L shape in a side view seen from the vehicle width direction. Specifically, the tail gate 5 includes an upper gate 60 and a rear gate 61.

The upper gate 60 is connected to a rear end part of the roof panel 23 rotatably around an axis line along the vehicle width direction. The upper gate 60 closes a portion of the rear opening part 50 that is located behind the roof panel 23 when the tail gate 5 is at a closed position. The upper gate 60 smoothly continues to an outer surface of the vehicle main body 3 when the tail gate 5 is at the closed position.

The rear gate 61 extends downward from a rear end part of the upper gate 60. The rear gate 61 closes a portion of the rear opening part 50 that opens rearward when the tail gate 5 is at the closed position. The rear gate 61 is locked to a striker or the like (not shown) that is provided on the partition wall 33 when the tail gate 5 is at the closed position. The rear gate 61 smoothly continues to the outer surface of the vehicle main body 3 when the tail gate 5 is at the closed position. The tail gate 5 may be formed, for example, to be rotatable around an axis line along the vertical direction. Further, the tail gate 5 may be opened and closed manually or may be opened and closed automatically.

The step 6 is formed in a plate shape that extends along the vehicle width direction. In the present embodiment, the length in the vehicle width direction of the step 6 is equal to the length of the lower end opening edge of the rear opening part 50. One end part of the step 6 is connected to an upper end part of the rear bumper 41 such that the step 6 is rotatable around an axis line along the vehicle width direction. In the present embodiment, the step 6 rotates between a use position and the storage position.

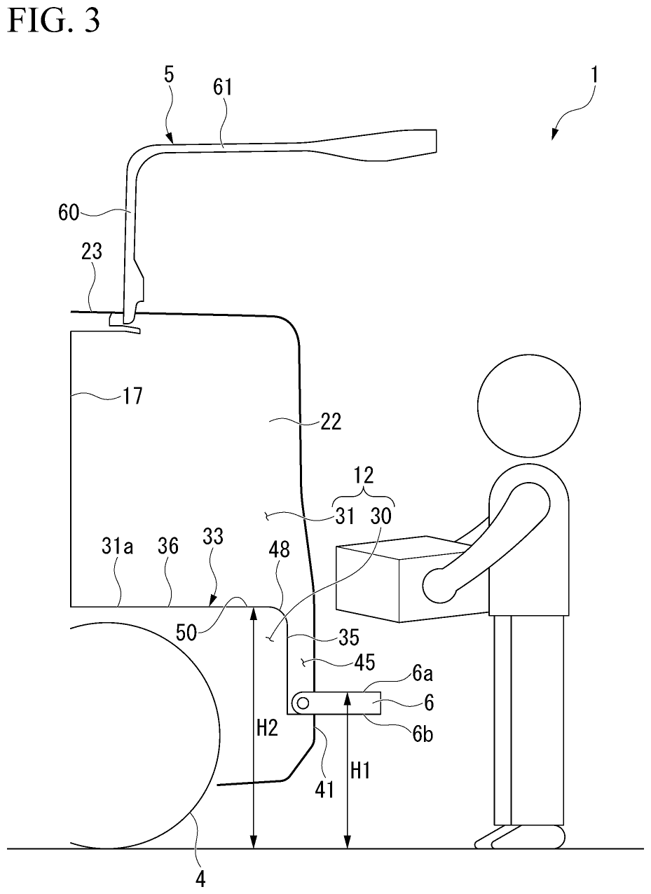

FIG. 3 is a schematic configuration view of the vehicle body rear part structure showing a state in which the step 6 is at the use position.

As shown in FIG. 3, the step 6 is arranged at the use position in a state where the thickness direction is the vertical direction and the step 6 protrudes further rearward than the rear bumper 41. A surface of the step 6 that faces upward at the use position constitutes a load placement surface 6a for placing a load. The load placement surface 6a is located at a lower position than the floor surface 31a when the step 6 is at the use position. A height (ground height) H1 from the ground of the load placement surface 6a when the step 6 is at the use position can be preferably, for example, in a range of ⅓ to ⅔ with respect to a ground height H2 of the floor surface 31a and can be particularly preferably in a range of 500 mm to 700 mm. A regulation part (not shown) that regulates a downward rotation of the step 6 when the step 6 is at the use position is provided on the vehicle main body 3.

As shown in FIG. 2, the step 6 is accommodated in the recessed part 45 at the storage position in a state where the thickness direction is a front-to-rear direction. At the storage position, another end part (upper end part) of the step 6 can be preferably arranged below the floor surface 31a and at a position equal to or lower than a lower end of the guide part 48 described above. However, the other end part of the step 6 may protrude further upward than the lower end of the guide part 48 at the storage position. At least the load placement surface 6a of the step 6 may stand upright at the storage position compared to the use position.

A surface (a lower surface at the use position) that faces rearward when the step 6 is at the storage position constitutes a design surface 6b that smoothly continues to the rear surface of the rear bumper 41. A lock mechanism (not shown) that regulates rotation of the step 6 to the use position when the step 6 is at the storage position is provided on the vehicle main body 3. The step 6 may be opened and closed manually or may be opened and closed automatically. Further, the step 6 may be movable to the use position only when the tail gate 5 is at the open position or may have a configuration in which the use position and the storage position can be switched independently of the position of the tail gate 5.

<Action>

Next, as an action of the vehicle 1 described above, an operation when a load is carried into and out of the load room 31 will be described.

As shown in FIG. 3, in order to carry in a load to the load room 31, first, the tail gate 5 is moved to the open position, and the rear opening part 50 is opened. Then, the step 6 is moved to the use position. Consequently, the load placement surface 6a that is located at a lower position than the floor surface 31a and that protrudes further rearward than the rear bumper 41 is arranged at a rear position of the vehicle main body 3. In this state, a user places a load that is placed on the ground or a load that is currently lifted onto the load placement surface 6a. Then, the load that is placed on the load placement surface 6a is further lifted and carried into the load room 31.

After the load is carried in, the step 6 is moved to the storage position, and the tail gate 5 is moved to the closed position.

Accordingly, carry-in work of the load is finished.

Subsequently, in order to carry out the load from the load room 31, similarly to the carry-in work described above, the tail gate 5 is moved to the open position, and the step 6 is moved to the use position. In this state, the load is removed from the load room 31 and is placed on the load placement surface 6a. Then, the load that is placed on the load placement surface 6a is sequentially carried.

After the load is carried out, the step 6 is moved to the storage position, and the tail gate 5 is moved to the closed position.

Accordingly, carry-out work of the load is finished.

In this way, the present embodiment is described using a configuration in which the step 6 having the load placement surface 6a is rotatably connected to the rear end part of the vehicle main body 3.

According to this configuration, when the step 6 is at the use position, the load placement surface 6a is arranged at a further rear position than the rear end of the vehicle main body 3 and at a lower position than the floor surface 31a of the load room 31. Therefore, a load can be placed on the load placement surface 6a when the load is carried into and out of the load room 31. Accordingly, it is possible to reduce the burden and improve the convenience when the load is carried into and out of the load room 31 compared to a case where the road is directly lifted from the ground to the floor surface 31a or the like.

The present embodiment is described using a configuration in which the load room 31 is arranged above the equipment accommodation part 30.

According to this configuration, since the equipment accommodation part 30 is arranged below the load room 31, even in a case where the floor surface 31a is set to a relatively high position, the load can be smoothly carried in and out by using the step 6.

The present embodiment is described using a configuration in which when the step 6 is at the storage position, the upper end (another end part) of the step 6 is located below the floor surface 31a.

According to this configuration, since the upper end of the step 6 does not protrude further upward than the floor surface 31a of the load room 31, for example, even in a case where the step 6 is not used, it is possible to prevent the upper end of the step 6 from interfering when the load is carried in and out.

The present embodiment is described using a configuration in which the guide part 48 is formed on the lower end opening edge of the rear opening part 50.

According to this configuration, the load is carried into and out of the load room 31 along the guide part 48, and thereby, it is possible to reduce the burden and improve the convenience when the load is carried into and out of the load room 31.

The present embodiment is described using a configuration in which the lock portion that locks the step 6 at the storage position is provided on the vehicle main body 3.

According to this configuration, it is possible to stably hold the step 6 at the storage position when the step 6 is not used.

### Second Embodiment

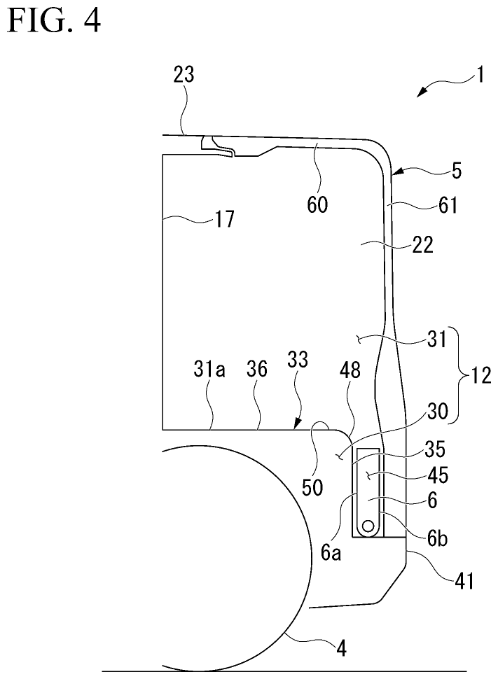

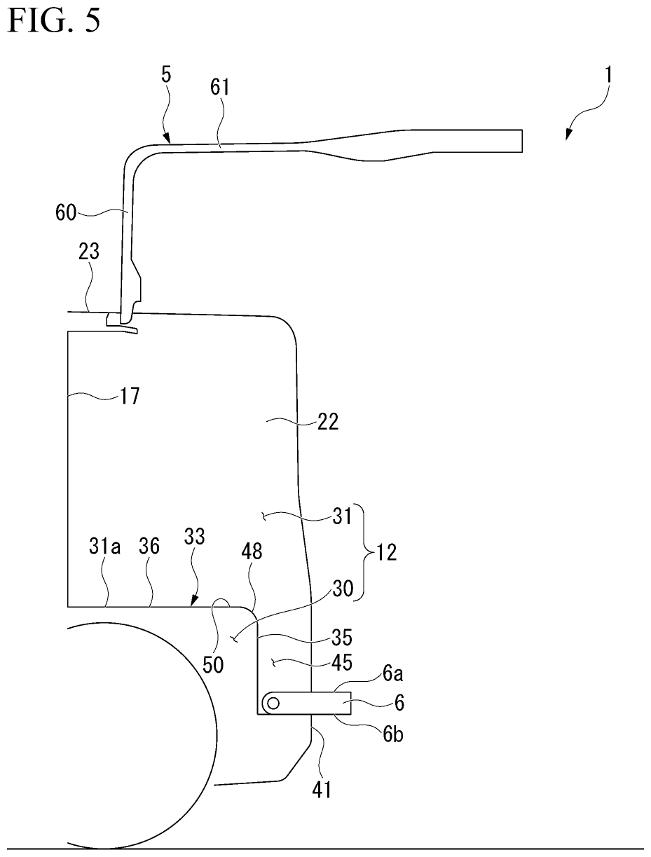

Next, a second embodiment is described. FIG. 4 and FIG. 5 are schematic configuration views of a vehicle body rear part structure according to the second embodiment which correspond to FIG. 2 and FIG. 3, respectively. The present embodiment is different from the above-described embodiment in that when the tail gate 5 is at the closed position, the step 6 is covered from the rear.

In the vehicle 1 shown in FIG. 4 and FIG. 5, the rear gate 61 of the tail gate 5 extends in the vertical direction at a further rear position than the step 6 described above. The lower end of the rear gate 61 is located at a lower position than the lower end of the step 6. Accordingly, the rear gate 61 covers the step 6 from the rear when the step 6 is at the storage position.

The rear gate 61 is locked to a striker or the like (not shown) that is provided on a skeleton member of the vehicle 1 when the tail gate 5 is at the closed position. The striker may be, for example, covered by the step 6 when the step 6 is at the use position and may be exposed to the outside when the step 6 is at the storage position. Thereby, it is possible to prevent the tail gate 5 from being at the closed position in a state where the step 6 is at the use position.

In the present embodiment, when the tail gate 5 is at the closed position and the step 6 is at the storage position, since the step 6 is covered by the tail gate 5, it is possible to prevent the step 6 from being exposed to the outside of the vehicle 1. Therefore, it is possible to improve the design property of the vehicle 1.

### Third Embodiment

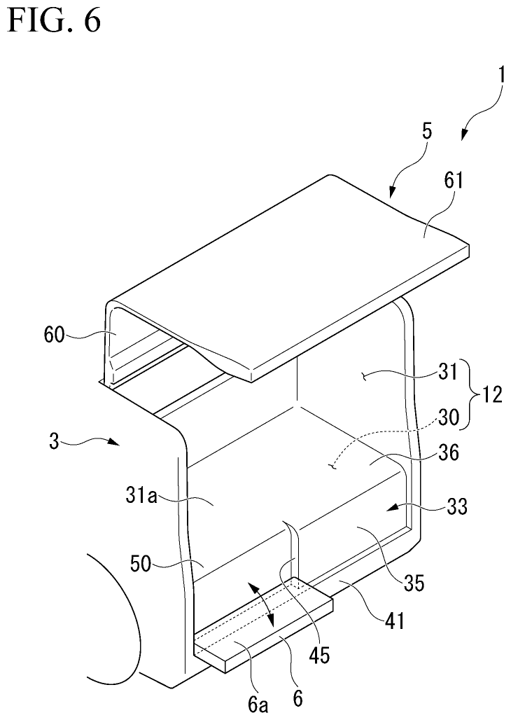

Next, a third embodiment is described. FIG. 6 is a perspective view of a vehicle body rear part structure viewed from a rearward direction according to the third embodiment. The above embodiment is described using a configuration in which the step 6 is provided corresponding to the entire length of the lower end opening edge of the rear opening part 50. On the other hand, the step 6 of the present embodiment is provided corresponding to a portion in the vehicle width direction of the lower end opening edge of the rear opening part 50. In the example shown in FIG. 6, the step 6 is provided close to one side in the vehicle width direction of the lower end opening edge of the rear opening part 50. The step 6 may be arranged at a middle part or may be arranged close to one side in the vehicle width direction as long as the step 6 has a configuration that is shorter than the lower end opening edge of the rear opening part 50.

According to this configuration, even when the step 6 is at the use position, a user can approach the rear opening part 50 by standing at the side of the step 6. In this case, since it is possible to access the rear opening part 50 without interposing the step 6, it is possible to further facilitate the transportation of the load between the load room 31 and the step 6.

### Fourth Embodiment

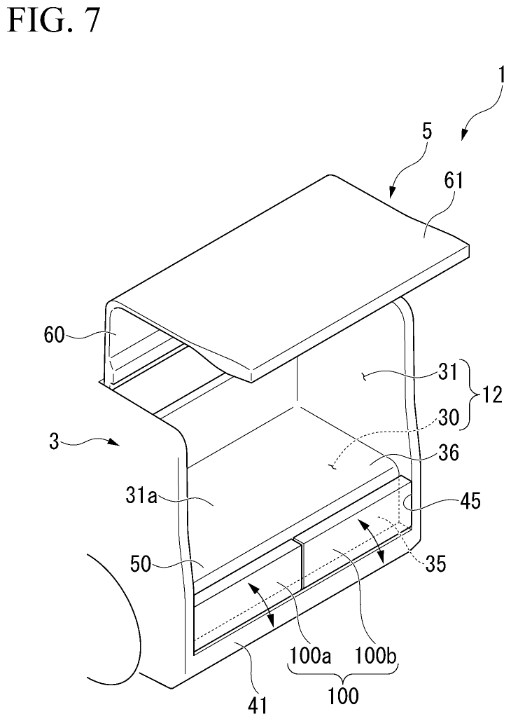

Next, a fourth embodiment is described. FIG. 7 is a perspective view of a vehicle body rear part structure viewed from a rearward direction according to the fourth embodiment. The present embodiment is different from the above-described embodiment in that a plurality of steps 6 are provided in the vehicle width direction.

A step 100 shown in FIG. 7 includes a first step 100a located at one side of the vehicle width direction and a second step 100b located on the other side of the vehicle width direction. Each of the steps 100 is rotatable independently of each other. The number, position, or the like of the steps 100 can be changed accordingly.

In the present embodiment, it is possible to select a step 100 that is set to the use position in accordance with the environment around the vehicle 1, the use mode of the vehicle 1, or the like. Therefore, it is possible to further improve the convenience.

### Other Modified Examples

Although preferred examples of the present invention have been described, the present invention is not limited to these examples. Addition, omission, substitution, and other modification of the configuration can be made without departing from the scope of the present invention. The present invention is not limited by the above description but is limited only by the appended claims.

For example, the above embodiment is described using a configuration in which the load room 31 is arranged above the equipment accommodation part 30; however, the embodiment is not limited to this configuration, and the configuration may not include the equipment accommodation part 30.

The above embodiment is described using a configuration in which the load placement surface 6a faces frontward by the step 6 rotating upward from the use position toward the storage position; however, the embodiment is not limited to this configuration. The load placement surface 6a may face rearward at the storage position by the step 6 rotating downward from the use position toward the storage position.

The component in the embodiments described above can be replaced by a known component without departing from the scope of the invention. The modified examples described above may be suitably combined.

What is claimed is:

1. A vehicle body rear part structure, comprising:
an opening/closing part that is capable of opening and closing a rear opening part of a vehicle main body that continues to an inside of a load room; and
a step that is rotatably connected to a rear end part of the vehicle main body and that has a load placement surface,
wherein the step rotates between a use position at which the load placement surface faces upward at a further rear position than a rear end of the vehicle main body and at a lower position than a floor surface of the load room and a storage position at which the load placement surface stands upright compared to the use position.

2. The vehicle body rear part structure according to claim 1,
wherein the load room is formed above an equipment accommodation part storing drive equipment of a vehicle and is separated by a partition wall, and
the floor surface is constituted of an upper surface of the partition wall.

3. The vehicle body rear part structure according to claim 1,
wherein when the step is at the storage position, an upper end of the step is located at a lower position than the floor surface.

4. The vehicle body rear part structure according to claim 1,
wherein a guide part that extends downward from the floor surface toward a rearward direction is formed on a lower end opening edge of the rear opening part.

5. The vehicle body rear part structure according to claim 1,
wherein the step is provided on a portion in a vehicle width direction of an entire area of the lower end opening edge of the rear opening part.

6. The vehicle body rear part structure according to claim 1,
wherein a plurality of steps are provided in a vehicle width direction at a rear end part of the vehicle main body.

7. The vehicle body rear part structure according to claim 1,
wherein a lock portion that locks the step located at the storage position is provided on the vehicle main body.
